(19) United States
(12) Patent Application Publication
(10) Pub. No.: US 2012/0046988 A1
(43) Pub. Date: Feb. 23, 2012

(54) METHOD AND APPARATUS FOR DETERMINING ACCURATE LOW SUPPLY LEVELS IN CONSUMABLES USED IN AN IMAGE PRODUCTION DEVICE

(75) Inventors: Jason TSONGAS, Rochester, NY (US); Matthew Scrafford, Fairport, NY (US)

(73) Assignee: XEROX CORPORATION, Norwalk, CT (US)

(21) Appl. No.: 12/857,920

(22) Filed: Aug. 17, 2010

(51) Int. Cl. G06Q 10/00; G03G 15/08

(52) U.S. Cl. 705/7.25; 399/27

(57) ABSTRACT

A method and apparatus for determining accurate low supply levels in consumables used in an image production device is disclosed. The method may include determining an average volume used per day of the consumable, determining an average delivery time for the consumable, determining an average installation time for the consumable, determining a low level threshold of the consumable based on average volume used per day of a consumable, average delivery time for the consumable, and average installation time for the consumable, determining if the fill level of the consumable is less than the determined low level threshold, wherein if it is determined that the fill level of the consumable is less than the determined low level threshold, ordering a replacement consumable.

### BACKGROUND

Disclosed herein is a method for determining accurate low supply levels in consumables used in an image production device, as well as corresponding apparatus and computer-readable medium.

For effective image production device management it is critical to provide customer replaceable unit (CRU) supplies using a just in time method. A supply item which arrives too soon has much greater potential for loss or allocation to an unintended device. Supplies which arrive too late make it impossible to meet contracted levels of service. Due to the complexity of manually determining the correct percent remaining level to set on the device for low consumable alerts, the value is often set higher than needed. The result is that helpdesk personnel must revisit the incident on a regular basis to determine when a supply order should actually occur, resulting in a substantial time and cost increase.

### SUMMARY

A method and apparatus for determining accurate low supply levels in consumables used in an image production device is disclosed. The method may include determining an average volume used per day of the consumable, determining an average delivery time for the consumable, the delivery time being an average elapsed time from the consumable being ordered to its delivery to the image production device's location, determining an average installation time for the consumable, the installation time being an average elapsed time from the consumable being delivered to the image production device's location and its installation in the image production device, determining a low level threshold of the consumable based on average volume used per day of a consumable, average delivery time for the consumable, and average installation time for the consumable, determining if the fill level of the consumable is less than the determined low level threshold, wherein if it is determined that the fill level of the consumable is less than the determined low level threshold, ordering a replacement consumable.

### BRIEF DESCRIPTION OF THE DRAWINGS

FIG. 1 is an exemplary diagram of an image production device in accordance with one possible embodiment of the disclosure;

FIG. 2 is an exemplary block diagram of the image production device in accordance with one possible embodiment of the disclosure; and

FIG. 3 is a flowchart of an exemplary accurate consumable low supply level determination process in accordance with one possible embodiment of the disclosure.

### DETAILED DESCRIPTION

Aspects of the embodiments disclosed herein relate to a method for determining accurate low supply levels in consumables used in an image production device, as well as corresponding apparatus and computer-readable medium.

The disclosed embodiments may include a method for determining accurate low supply levels in consumables used in an image production device. The method may include determining an average volume used per day of the consumable, determining an average delivery time for the consumable, the delivery time being an average elapsed time from the consumable being ordered to its delivery to the image production device's location, determining an average installation time for the consumable, the installation time being an average elapsed time from the consumable being delivered to the image production device's location and its installation in the image production device, determining a low level threshold of the consumable based on average volume used per day of a consumable, average delivery time for the consumable, and average installation time for the consumable, determining if the fill level of the consumable is less than the determined low level threshold, wherein if it is determined that the fill level of the consumable is less than the determined low level threshold, ordering a replacement consumable.

The disclosed embodiments may further include an image production device that may include a communication interface that facilitates communications, and a consumable supply management unit that determines an average volume used per day of the consumable, determines an average delivery time for the consumable, determines an average installation time for the consumable, determines a low level threshold of the consumable based on average volume used per day of a consumable, average delivery time for the consumable, and average installation time for the consumable, determines if the fill level of the consumable is less than the determined low level threshold, wherein if the consumable supply management unit determines that the fill level of the consumable is less than the determined low level threshold, the consumable supply management unit orders a replacement consumable through the communication interface, wherein the delivery time is an average elapsed time from the consumable being ordered to its delivery to the image production device's location, and the installation time is an average elapsed time from the consumable being delivered to the image production device's location and its installation in the image production device.

The disclosed embodiments may include a computer-readable medium storing instructions for controlling a computing device for determining accurate low supply levels in consumables used in an image production device. The instructions may include determining an average volume used per day of the consumable, determining an average delivery time for the consumable, the delivery time being an average elapsed time from the consumable being ordered to its delivery to the image production device's location, determining an average installation time for the consumable, the installation time being an average elapsed time from the consumable being delivered to the image production device's location and its installation in the image production device, determining a low level threshold of the consumable based on average volume used per day of a consumable, average delivery time for the consumable, and average installation time for the consumable, determining if the fill level of the consumable is less than the determined low level threshold, wherein if it is determined that the fill level of the consumable is less than the determined low level threshold, ordering a replacement consumable.

The disclosed embodiments may propose to determine accurate low supply levels in consumables used in image production devices. In this manner, the disclosed embodiments may provide for a method of determining the correct low consumable alert messaging percentage level and to automatically set and reset the value on each device. The level may be determined by taking into account average volume, delivery time and installation time. The process may also take into account historical data and over time would be able to further refine the percentage level being set on the device. The computation may occur on the device management application and may allow for changes to the percentage levels on a regular basis to account for changes in device usage.

Note that the term “average” may mean any numerical summary or calculation of inputs that is related to an output, to include but not be limited to a mean, a median, a weighted average, etc., for example.

The consumable supply management unit may continually update the low toner threshold based on usage and actual ship times and installation times for a particular device. A possible process of calculating the low supply threshold may include the following values that may be used in the calculation:
I: Installation Date. This value may be determined based on one of the following items; when the toner cartridge serial number changes, when the device goes from no toner ready state, or when the device is detected at 90% or higher after a low toner.
O: Order Date. This value may come from the help desk system and may occur when the supply is ordered
Y: yield. The value may be the average yield of the toner cartridge.
A: Days to delivery. This value may be how long it takes to deliver the toner based on the lowest cost delivery method.
S: Sag Time. This value may be an extra time that is added to compensate for slight changes in delivery. In this manner, the sag time may be a percentage of the delivery time, for example.
B: This value may be a percentage of delivery time to calculate Sag Time.
D: This value may be a number of incidents to consider. This value will be used to get the average time it takes from order time (O) to installation time (I).
V: This value may be an average volume per day. The average volume per day may be based on a rolling average, for example.
E: This value may be a number of days used in the average volume calculation.

The sag time may be calculated based on the days to delivery and a percentage to add to that value. This value may be calculated when one of the two values may be changed and may be stored within the system.

For example, the calculation for low supply level setting may include the following equations using the variables described above:

S=(B/100)*A

((I−O)−S)^{D}/D=average time between order and installation (X)

If (X−A)>(A*0.25) calculate extra time past delivery date.

X−A=Extra days supply is left on site before install (K)

else

K=0

(Y/(V*(K+A+S)))/100=percent low toner level.

In this manner, dynamic device-based low toner thresholds based on usage and actual ship times using information may be shared by the image production device and the help desk system/device management application. The process may be performed by the image production device or by a central image production device management server, for example. As a result, there may be more accurate “just in time” delivery of device supplies, reduced supplies leakage due to supplies arriving earlier than needed, reduced machine down time due to supplies arriving later than needed, the need for manual estimating of the appropriate consumable low threshold may be removed, and automatic supplies reordering may be facilitated thus requiring less help desk interaction and thus reducing maintenance costs.

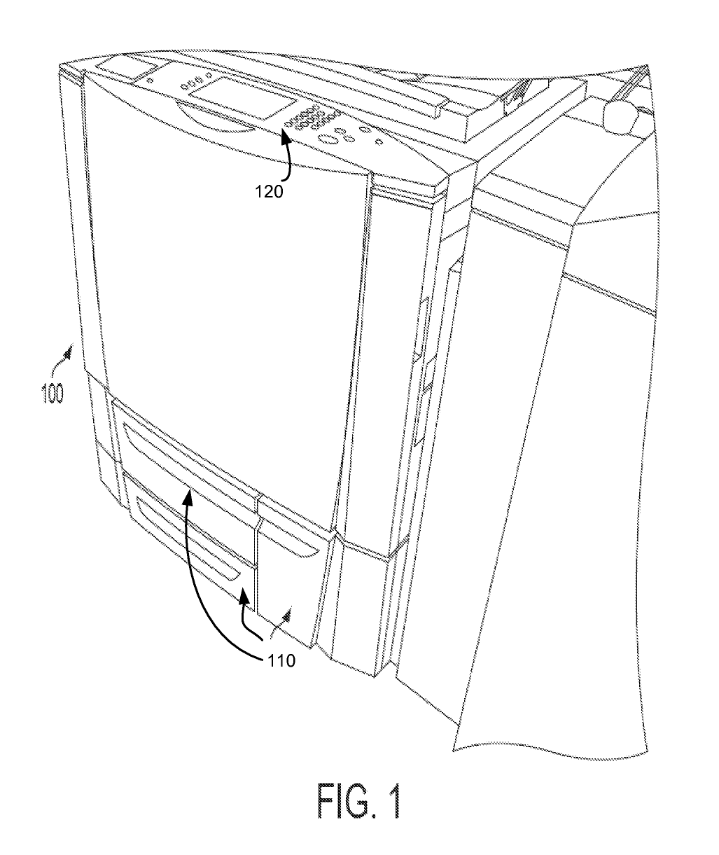

FIG. 1 is an exemplary diagram of an image production device 100 in accordance with one possible embodiment of the disclosure. The image production device 100 may be any device that may be capable of making image production documents (e.g., printed documents, copies, etc.) including a copier, a printer, a facsimile device, and a multi-function device (MFD), for example.

The image production device 100 may include one or more media tray doors 110 and a local user interface 120. The one or more media tray doors 110 may provide access to one or more media trays that contain media. The one or more media tray doors 110 may be opened by a user so that media may be checked, replaced, or to investigate a media misfeed or jam, for example.

The user interface 120 may contain one or more display screens (which may be a touchscreen or simply a display), and a number of buttons, knobs, switches, etc. to be used by a user to control image production device 100 operations. The one or more display screen may also display warnings, alerts, instructions, and information to a user. While the user interface 120 may accept user inputs, another source of image data and instructions may include inputs from any number of computers to which the printer is connected via a network.

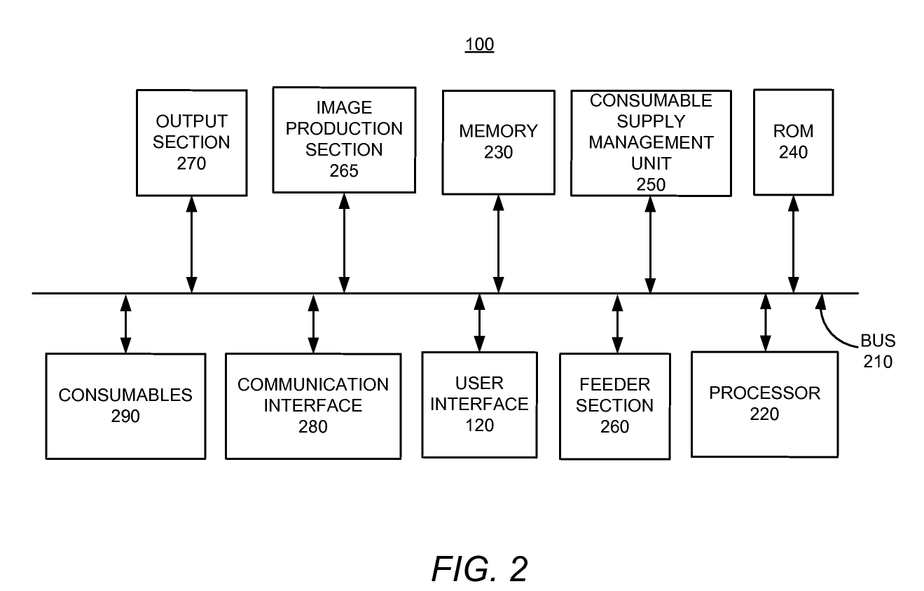

FIG. 2 is an exemplary block diagram of the image production device 100 in accordance with one possible embodiment of the disclosure. The image production device 100 may include a bus 210, a processor 220, a memory 230, a read only memory (ROM) 240, a consumable supply management unit 250, a feeder section 260, an output section 270, a user interface 120, a communication interface 280, one or more consumables 290, and an image production section 265. Bus 210 may permit communication among the components of the image production device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

The image production section 265 may include hardware to produce image on media and may include an image printing and/or copying section, a scanner, a fuser, etc., for example. The feeder section 260 may be stand-alone or integrated and may store and dispense media sheets on which images are to be printed. The output section 270 may include hardware for stacking, folding, stapling, binding, etc., prints which are output from the image production section. If the image production device 100 is also operable as a copier, the image production device 100 may further includes a document feeder and scanner which may operate to convert signals from light reflected from original hard-copy image into digital signals, which are in turn processed to create copies with the image production section 265.

With reference to feeder section 260, the section may include one or more media trays, each of which stores a media stack or print sheets (“media”) of a predetermined type (size, weight, color, coating, transparency, etc.) and may include a feeder to dispense one of the media sheets therein as instructed. The media trays may be accessed by a user by opening the one or more media tray doors 110. The one or more media tray door sensors may sense if one or more media tray door 110 is either open or closed. The one or more media tray door sensors may be any sensors known to one of skill in the art, such as contact, infra-red, magnetic, or light-emitting diode (LED) sensors, for example. The one or more media tray size sensors may be any sensors that may detect media size in a media known to one of skill in the art, including switches, etc.

User interface 120 may include one or more conventional mechanisms that permit a user to input information to and interact with the image production unit 100, such as a keyboard, a display, a mouse, a pen, a voice recognition device, touchpad, buttons, etc., for example. Output section 270 may include one or more conventional mechanisms that output image production documents to the user, including output trays, output paths, finishing section, etc., for example. Consumables 290 may be products that are purchased or provided from a supplier recurrently which are depleted through the operation of the image production device 100 and then discarded. For example, for image production devices 100, consumables 290 may represent one or more consumables 290 that are used by the image production device 100, such as a toner cartridge, a solid ink block, a liquid ink cartridge, etc., for example.

The image production device 100 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 100 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 100, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

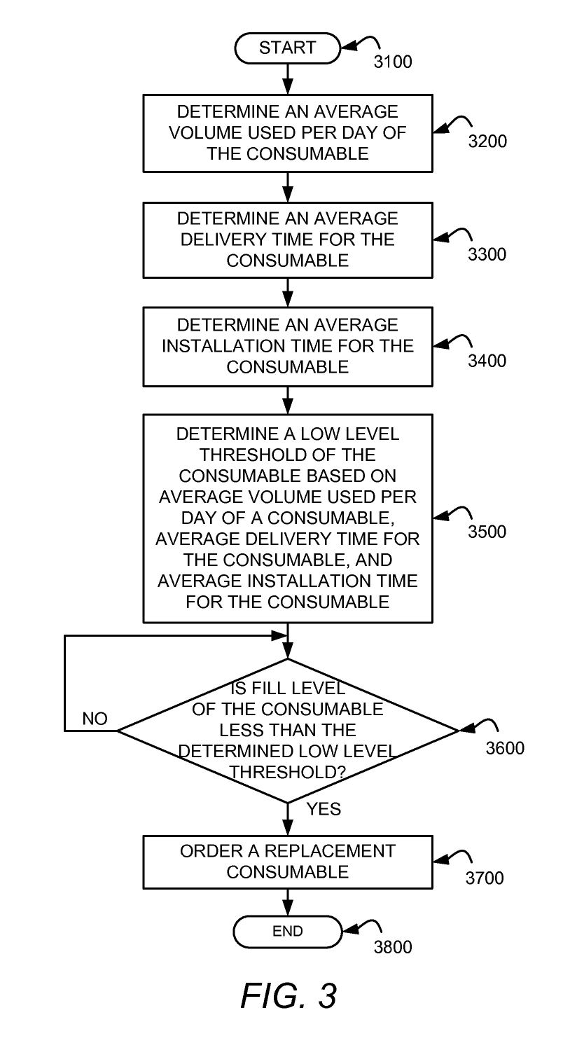

The operation of the consumable supply management unit 250 will be discussed below in relation to the flowchart in FIG. 3.

FIG. 3 is a flowchart of an accurate consumable low supply determination process in accordance with one possible embodiment of the disclosure. The process may begin at step 3100 and may continue to step 3200 where the consumable supply management unit 250 may determine an average volume used per day of the consumable 290. At step 3300, the consumable supply management unit 250 may determine an average delivery time for the consumable 290. The delivery time may be an average elapsed time from the consumable 290 being ordered to its delivery to the image production device's location.

At step 3400, the consumable supply management unit 250 may determine an average installation time for the consumable 290. The installation time may be an average elapsed time from the consumable 290 being delivered to the image production device's location and its installation in the image production device 100.

At step 3500, the consumable supply management unit 250 may determine a low level threshold of the consumable 290 based on average volume used per day of a consumable, average delivery time for the consumable 290, and average installation time for the consumable 290. The consumable supply management unit 250 may also determine a sag time. The sag time may be extra time for slight changes in delivery, such as for holidays, weekends, seasonal issues, etc. The sag time may be determined as a percentage of the delivery time of the consumable 290. The consumable supply management unit 250 may then determine the low level threshold of the consumable 290 based on average volume used per day of a consumable 290, average delivery time for the consumable 290, average installation time for the consumable 290, and the sag time, for example.

The consumable supply management unit 250 may determine the low level threshold of the consumable 290 from the equation:

(Y/(V*(K+A+S)))/100,

where Y is an average yield of the consumable 290, V is the average volume used per day of the consumable 290, K is extra days supply is left on site before installation, A is a number of days it takes for delivery, and S is sag time.

At step 3600, the consumable supply management unit 250 may determine if the fill level of the consumable 290 is less than the determined low level threshold. If the consumable supply management unit 250 determines that the fill level of the consumable 290 is not less than the determined low level threshold, the process may return to step 3600.

If at step 3600, the consumable supply management unit 250 determines that the fill level of the consumable 290 is not less than the determined low level threshold, at step 700, the consumable supply management unit 250 may order a replacement consumable 290 through the communication interface 280. The consumable supply management unit 250 may send a message to the user interface 120 for display to the user that the consumable 290 has been ordered. The user interface 120 may also display a low level indication that may (or may not) have to be cleared by the next user or the image production device administrator, for example. The user or device administrator may have opted to manually order consumables 290 so the warning indicator will be alert that person to order the consumable 290 from a supplier. The process may then go to step 3800 and end.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for determining accurate low supply levels in a consumable used in an image production device, comprising:
determining an average volume used per day of the consumable;
determining an average delivery time for the consumable, the delivery time being an average elapsed time from the consumable being ordered to its delivery to the image production device's location;
determining an average installation time for the consumable, the installation time being an average elapsed time from the consumable being delivered to the image production device's location and its installation in the image production device;
determining a low level threshold of the consumable based on average volume used per day of a consumable, average delivery time for the consumable, and average installation time for the consumable;
determining if the fill level of the consumable is less than the determined low level threshold, wherein if it is determined that the fill level of the consumable is less than the determined low level threshold,
ordering a replacement consumable.

2. The method of claim 1, further comprising:
determining a sag time, the sag time being extra time for slight changes in delivery; and
determining a low level threshold of the consumable based on average volume used per day of a consumable, average delivery time for the consumable, average installation time for the consumable, and the sag time.

3. The method of claim 2, wherein the sag time is a percentage of the delivery time.

4. The method of claim 3, wherein the low level threshold of the consumable is determined from the equation:
(Y/(V*(K+A+S)))/100,
wherein Y is an average yield of the consumable, V is the average volume used per day of the consumable, K is extra days supply is left on site before installation, A is a number of days it takes for delivery, and S is sag time.

5. The method of claim 1, wherein the consumable is one of a toner cartridge, a solid ink block, and a liquid ink cartridge.

6. The method of claim 1, further comprising:
sending a message at to a user interface that the consumable has been ordered.

7. The method of claim 1, wherein the image production device is one of a copier, a printer, a facsimile device, and a multi-function device.

8. An image production device, comprising:
a communication interface that facilitates communications; and
a consumable supply management unit that determines an average volume used per day of the consumable, determines an average delivery time for the consumable, determines an average installation time for the consumable, determines a low level threshold of the consumable based on average volume used per day of a consumable, average delivery time for the consumable, and average installation time for the consumable, determines if the fill level of the consumable is less than the determined low level threshold, wherein if the consumable supply management unit determines that the fill level of the consumable is less than the determined low level threshold, the consumable supply management unit orders a replacement consumable through the communication interface,
wherein the delivery time is an average elapsed time from the consumable being ordered to its delivery to the image production device's location, and the installation time is an average elapsed time from the consumable being delivered to the image production device's location and its installation in the image production device.

9. The image production device of claim 8, wherein the consumable supply management unit determines a sag time, the sag time being extra time for slight changes in delivery, and determines a low level threshold of the consumable based on average volume used per day of a consumable, average delivery time for the consumable, average installation time for the consumable, and the sag time.

10. The image production device of claim 9, wherein the sag time is a percentage of the delivery time.

11. The image production device of claim 10, wherein the consumable supply management unit determines the low level threshold of the consumable from the equation:
(Y/(V*(K+A+S)))/100,
wherein Y is an average yield of the consumable, V is the average volume used per day of the consumable, K is extra days supply is left on site before installation, A is a number of days it takes for delivery, and S is sag time.

12. The image production device of claim 8, wherein the consumable is one of a toner cartridge, a solid ink block, and a liquid ink cartridge.

13. The image production device of claim 8, further comprising:
a user interface, wherein the consumable supply management unit sends a message at to the user interface that the consumable has been ordered.

14. The image production device of claim 8, wherein the image production device is one of a copier, a printer, a facsimile device, and a multi-function device.

15. A computer-readable medium storing instructions for controlling a computing device for determining accurate low supply levels in a consumable used in an image production device, the instructions comprising:
determining an average volume used per day of the consumable;
determining an average delivery time for the consumable, the delivery time being an average elapsed time from the consumable being ordered to its delivery to the image production device's location;
determining an average installation time for the consumable, the installation time being an average elapsed time from the consumable being delivered to the image production device's location and its installation in the image production device;
determining a low level threshold of the consumable based on average volume used per day of a consumable, average delivery time for the consumable, and average installation time for the consumable;
determining if the fill level of the consumable is less than the determined low level threshold, wherein if it is determined that the fill level of the consumable is less than the determined low level threshold,
ordering a replacement consumable.

16. The computer-readable medium of claim 15, further comprising:
determining a sag time, the sag time being extra time for slight changes in delivery; and
determining a low level threshold of the consumable based on average volume used per day of a consumable, average delivery time for the consumable, average installation time for the consumable, and the sag time.

17. The computer-readable medium of claim 16, wherein the sag time is a percentage of the delivery time.

18. The computer-readable medium of claim 17, wherein the low level threshold of the consumable is determined from the equation:
(Y/(V*(K+A+S)))/100,
wherein Y is an average yield of the consumable, V is the average volume used per day of the consumable, K is extra days supply is left on site before installation, A is a number of days it takes for delivery, and S is sag time.

19. The computer-readable medium of claim 15, wherein the consumable is one of a toner cartridge, a solid ink block, and a liquid ink cartridge.

20. The computer-readable medium of claim 15, further comprising:
sending a message at to a user interface that the consumable has been ordered.

21. The computer-readable medium of claim 15, wherein the image production device is one of a copier, a printer, a facsimile device, and a multi-function device.
